(19) United States
(12) Patent Application Publication
(10) Pub. No.: US 2024/0249737 A1
(43) Pub. Date: Jul. 25, 2024

(54) AUDIO ENCODING AND DECODING METHOD AND RELATED PRODUCT

(71) Applicant: TENCENT TECHNOLOGY (SHENZHEN) COMPANY LIMITED, Shenzhen (CN)

(72) Inventors: Chao HUA, Shenzhen (CN); Fei HUANG, Shenzhen (CN)

(21) Appl. No.: 18/624,396

(22) Filed: Apr. 2, 2024

Related U.S. Application Data
(63) Continuation of application No. PCT/CN2023/085872, filed on Apr. 3, 2023.

(30) Foreign Application Priority Data
May 19, 2022 (CN) 202210546928.4

(51) Int. Cl. G10L 19/022; G10L 19/00; G10L 19/038; G10L 19/04

(52) U.S. Cl. CPC G10L 19/022; G10L 19/038; G10L 19/04; G10L 2019/0001

(57) ABSTRACT

An audio decoding method performed by a computer device includes obtaining encoding vectors of audio frames in an audio frame sequence, and performing, in response to a current audio frame in the audio frame sequence being to be decoded, up-sampling on an encoding vector of a historical audio frame to obtain an up-sampling feature value describing the historical audio frame. The historical audio frame includes one or more audio frames decoded before the current audio frame in the audio frame sequence. The method further includes performing, based on the up-sampling feature value, up-sampling on an encoding vector of the current audio frame to obtain decoded data of the current audio frame.

### CROSS-REFERENCE TO RELATED APPLICATIONS

This application is a continuation of International Application No. PCT/CN2023/085872, filed on Apr. 3, 2023, which claims priority to Chinese Patent Application No. 202210546928.4, entitled “AUDIO ENCODING AND DECODING METHOD AND RELATED PRODUCT” and filed with the China National Intellectual Property Administration on May 19, 2022, the entire contents of which are incorporated herein by reference.

### FIELD OF THE TECHNOLOGY

This disclosure relates to the field of audio and video technologies, and in particular, to an audio encoding and decoding method, an audio encoding and decoding apparatus, a computer-readable storage medium, an electronic device, and a computer program product.

### BACKGROUND OF THE DISCLOSURE

Performing encoding and decoding processing on media data such as audio and video can implement compression and transmission of the media data, thereby reducing network transmission costs of the media data and improving network transmission efficiency.

During encoding processing, the media data may be lost, resulting in poor media data quality.

### SUMMARY

In accordance with the disclosure, there is provided an audio decoding method performed by a computer device and including obtaining encoding vectors of audio frames in an audio frame sequence, and performing, in response to a current audio frame in the audio frame sequence being to be decoded, up-sampling on an encoding vector of a historical audio frame to obtain an up-sampling feature value describing the historical audio frame. The historical audio frame includes one or more audio frames decoded before the current audio frame in the audio frame sequence. The method further includes performing, based on the up-sampling feature value, up-sampling on an encoding vector of the current audio frame to obtain decoded data of the current audio frame.

Also in accordance with the disclosure, there is provided an audio encoding method performed by a computer device and including obtaining audio data of audio frames in an audio frame sequence, and performing, in response to a current audio frame in the audio frame sequence being to be encoded, down-sampling on audio data of a historical audio frame to obtain a down-sampling feature value describing the historical audio frame. The historical audio frame includes one or more audio frames encoded before the current audio frame in the audio frame sequence. The method further includes performing, based on the down-sampling feature value, down-sampling on the audio data of the current audio frame to obtain an encoding vector of the current audio frame.

Also in accordance with the disclosure, there is provided an electronic device including one or more processors and one or more memories storing one or more computer programs that, when executed by the one or more processors, cause the electronic device to obtain encoding vectors of audio frames in an audio frame sequence, perform, in response to a current audio frame in the audio frame sequence being to be decoded, up-sampling on an encoding vector of a historical audio frame to obtain an up-sampling feature value describing the historical audio frame that includes one or more audio frames decoded before the current audio frame in the audio frame sequence, and perform, based on the up-sampling feature value, up-sampling on an encoding vector of the current audio frame to obtain decoded data of the current audio frame.

### BRIEF DESCRIPTION OF THE DRAWINGS

Accompanying drawings herein are incorporated into and constitute a part of this specification, show embodiments that conform to this application, and are used together with this specification to describe the principle of this application. Apparently, the accompanying drawings in the following description show merely some embodiments of this application, and a person of ordinary skill in the art may still derive other drawings from these accompanying drawings without creative efforts.

FIG. 1 is a schematic diagram of an exemplary system architecture to which a technical solution according to an embodiment of this application is applicable.

FIG. 2 is a schematic diagram showing placement manners of a video encoding apparatus and a video decoding apparatus in a streaming transmission environment.

FIG. 3 is a network structural block diagram of a codec constructed based on a convolutional neural network.

FIG. 4 is a flowchart of an audio decoding method according to an embodiment of this application.

FIG. 5 is a flowchart of steps of performing an audio decoding method based on a convolutional neural network including a plurality of up-sampling layers according to an embodiment of this application.

FIG. 6 is a schematic diagram of a network module implementing data encoding and decoding processing according to an embodiment of this application.

FIG. 7 is a schematic diagram showing a principle of performing normalization processing on channel feature values outputted by a plurality of sampling channels according to an embodiment of this application.

FIG. 8 is a flowchart of steps of performing audio frame decoding processing based on querying a codebook according to an embodiment of this application.

FIG. 9 is a schematic diagram showing a principle of determining an encoding vector based on data mapping according to an embodiment of this application.

FIG. 10 is a flowchart of steps of training a quantizer according to an embodiment of this application.

FIG. 11 is a flowchart of steps of an audio encoding method according to an embodiment of this application.

FIG. 12 is a flowchart of steps of performing an audio encoding method based on a convolutional neural network including a plurality of down-sampling layers according to an embodiment of this application.

FIG. 13 is a flowchart of steps of performing model training for an encoder and a decoder according to an embodiment of this application.

FIG. 14 is a schematic diagram showing a principle of performing encoding and decoding model training based on a generative adversarial network according to an embodiment of this application.

FIG. 15 is a structural block diagram of an audio decoding apparatus according to an embodiment of this application.

FIG. 16 is a structural block diagram of an audio encoding apparatus according to an embodiment of this application.

FIG. 17 is a structural block diagram of a computer system of an electronic device according to an embodiment of this application.

### DESCRIPTION OF EMBODIMENTS

Exemplary implementations are now described more comprehensively with reference to the accompanying drawings. However, the examples of implementations may be implemented in multiple forms, and it should not be understood as being limited to the examples of implementations described herein. Conversely, the implementations are provided to make this application more comprehensive and complete, and comprehensively convey the idea of the examples of the implementations to a person skilled in the art.

The block diagrams shown in the accompany drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples for descriptions, do not need to include all content and operations/steps, and do not need to be performed in the described orders either. For example, some operations/steps may be further divided, while some operations/steps may be combined or partially combined. Therefore, an actual execution order may change according to an actual case.

“Plurality of” mentioned in the specification means two or more. “And/or” describes an association relationship for describing associated objects and represents that three relationships may exist. For example, A and/or B may represent the following three cases: Only A exists, both A and B exist, and only B exists. The character “/” generally represents an “or” relationship between the associated objects.

In specific implementations of this application, relevant data of a user such as audio frame is involved. When various embodiments of this application are applied to specific products or technologies, separate permission or separate consent of the user needs to be obtained, and collection, use, and processing of the relevant data need to comply with relevant laws, regulations, and standards of relevant countries and regions.

Related terms or abbreviations involved in the embodiments of this application are explained as follows:

Convolutional neural network: In the field of multimedia data processing such as text, images, audio and video, the convolutional neural network is the most successfully applied deep learning structure. The convolutional neural network includes a plurality of convolutional layers, generally including a convolutional layer, a pooling layer, an activation layer, a normalization layer, a fully connected layer, and the like.

Audio encoding and decoding: An audio encoding process is to compress an audio into smaller data, and a decoding process is to restore the smaller data to the audio. The encoded smaller data is configured for network transmission and occupies less bandwidth.

Audio sampling rate: The audio sampling rate describes a quantity of pieces of data included in unit time (1 second). For example, a 16k sampling rate includes 16,000 sampling points, and each sampling point corresponds to a short integer.

Codebook: A collection of a plurality of vectors, where both an encoder and a decoder store a same codebook.

Quantization: Find a closest vector to an input vector in the codebook, return the closest vector as a replacement for the input vector, and return a corresponding codebook index position.

Quantizer: The quantizer is responsible for quantizing work and updating vectors within the codebook.

Weak network environment: An environment with poor network transmission quality, such as a bandwidth below 3 kpbs.

Audio frame: It represents a minimum speech duration for a single transmission in a network.

Short time Fourier transform (STFT): A long-time signal is divided into several shorter signals of equal length, and then the Fourier transform of each shorter segment is calculated. The STFT is usually used to describe changes in frequency domain and time domain, and is an important tool in time-frequency analysis.

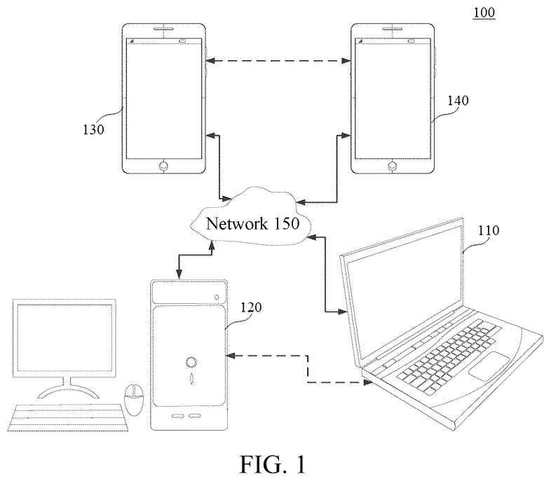

FIG. 1 is a schematic diagram of an exemplary system architecture to which a technical solution according to an embodiment of this application is applicable.

As shown in FIG. 1, a system architecture 100 includes a plurality of terminal devices, and the terminal devices may communicate with each other through, such as, a network 150. For example, the system architecture 100 may include a first terminal device 110 and a second terminal device 120 that communicate with each other through the network 150. In the embodiment of FIG. 1, the first terminal device 110 and the second terminal device 120 perform unidirectional data transmission.

For example, the first terminal device 110 may encode audio and video data (such as an audio and video data stream acquired by the first terminal device 110) to transmit to the second terminal device 120 through the network 150, and the encoded audio and video data is transmitted in a form of one or more encoded audio and video bitstreams. The second terminal device 120 may receive the encoded audio and video data from the network 150, decode the encoded audio and video data to restore the audio and video data, and perform content playback or display based on the restored audio and video data.

In an embodiment of this application, the system architecture 100 may include a third terminal device 130 and a fourth terminal device 140 that perform bidirectional transmission of the encoded audio and video data, and the bidirectional transmission may occur, for example, during an audio and video conference. For the bidirectional data transmission, each terminal device in the third terminal device 130 and the fourth terminal device 140 may encode the audio and video data (for example, the audio and video data stream acquired by the terminal device), to transmit to the other terminal devices in the third terminal device 130 and the fourth terminal device 140 through the network 150. Each terminal device in the third terminal device 130 and the fourth terminal device 140 may further receive the encoded audio and video data transmitted by the another terminal device in the third terminal device 130 and the fourth terminal device 140, may decode the encoded audio and video data to restore the audio and video data, and may perform content playback or display based on the restored audio and video data.

In the embodiment of FIG. 1, the first terminal device 110, the second terminal device 120, the third terminal device 130, and the fourth terminal device 140 may be personal computers and smart phones, but the principles disclosed in this application may not be limited thereto. The embodiments disclosed in this application are applicable to a laptop computer, a tablet computer, a media player, and/or a dedicated audio and video conference device. The network 150 represents any quantity of networks that transmit the encoded audio and video data among the first terminal device 110, the second terminal device 120, the third terminal device 130, and the fourth terminal device 140, and includes, for example, a wired and/or wireless communication network. The communication network 150 may exchange data in circuit-switched and/or packet-switched channels. The network may include a telecommunication network, a local area network, a wide area network, and/or the Internet. For an objective of this application, unless explained below, the architecture and topology of the network 150 may be immaterial to the operations disclosed in this application.

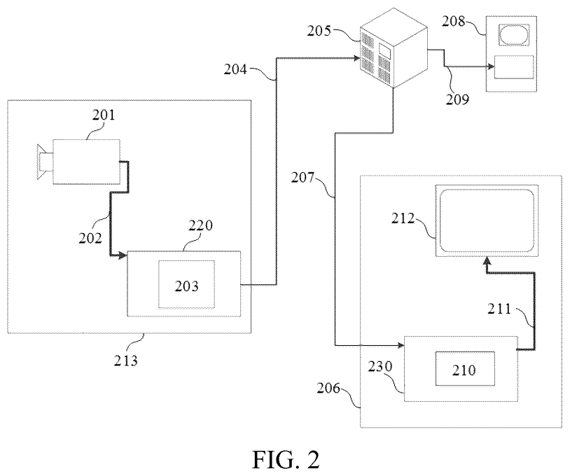

In an embodiment of this application, FIG. 2 schematically illustrates placement manners of an audio and video encoding apparatus and an audio and video decoding apparatus in a streaming transmission environment. The subject disclosed in this application may be equally applicable to other applications that support audio and video, including, for example, storing compressed audios and videos on digital media such as an audio and video conference, a digital TV (television), a CD, a DVD, and a memory stick.

A streaming transmission system may include an acquisition subsystem 213, the acquisition subsystem 213 may include an audio and video source 201 such as a microphone and a camera, and the audio and video source creates an uncompressed audio and video data stream 202. Compared with encoded audio and video data 204 (or an encoded audio and video bitstream 204), the audio and video data stream 202 is depicted as a thick line to emphasize a high data volume of the audio and video data stream. The audio and video data stream 202 may be processed by an electronic device 220, where the electronic device 220 includes an audio and video encoding apparatus 203 coupled to the audio and video source 201. The audio and video encoding apparatus 203 may include hardware, software, or a combination of hardware and software to implement or perform various aspects of the disclosed subject described in greater detail below. Compared with the audio and video data stream 202, the encoded audio and video data 204 (or the encoded audio and video bitstream 204) is depicted as a thin line to emphasize a lower data volume of the encoded audio and video data 204 (or the encoded audio and video bitstream 204), which may be stored on a streaming transmission server 205 for future use. One or more streaming transmission client subsystems, such as a client subsystem 206 and a client subsystem 208 in FIG. 2, may access the streaming transmission server 205 to retrieve a copy 207 and a copy 209 of the encoded audio and video data 204. The client subsystem 206 may include, such as, an audio and video decoding apparatus 210 in an electronic device 230. The audio and video decoding apparatus 210 decodes an incoming copy 207 of the encoded audio and video data and generates an output audio and video data stream 211 that can be presented on an output end 212 (such as, a speaker and a display) or another presentation apparatus. In some streaming transmission systems, the encoded audio and video data 204, the audio and video data 207, and the audio and video data 209 (such as, audio and video bitstreams) may be encoded based on some audio and video encoding/compression standards.

The electronic device 220 and the electronic device 230 may include other assemblies not shown in the figure. For example, the electronic device 220 may include an audio and video decoding apparatus, and the electronic device 230 may also include an audio and video encoding apparatus.

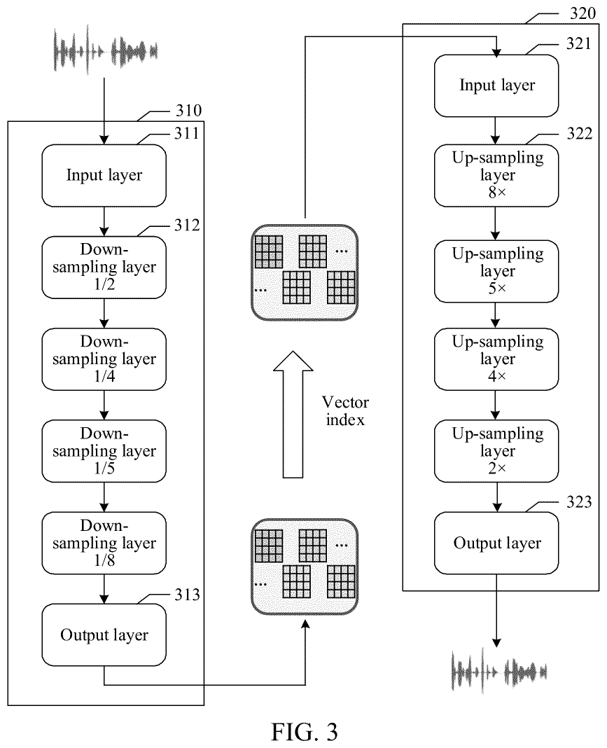

FIG. 3 is a network structural block diagram of a codec constructed based on a convolutional neural network according to an embodiment of this application.

As shown in FIG. 3, a network structure of the codec includes an encoder 310 and a decoder 320, where the encoder 310 may be used as software to implement the audio and video encoding apparatus 203 shown in FIG. 2, and the decoder 320 may be used as software to implement the audio and video decoding apparatus 210 shown in FIG. 2.

The audio data may be encoded and compressed through the encoder 310 at a data transmit end. In an embodiment of this application, the encoder 310 may include an input layer 311, one or more down-sampling layers 312, and an output layer 313.

For example, the input layer 311 and the output layer 313 may be convolutional layers constructed based on a one-dimensional convolution kernel, and four down-sampling layers 312 are sequentially connected between the input layer 311 and the output layer 313. Based on an application scenario, functions of network layers are explained as follows:

In an input stage of the encoder, data sampling is performed on to-be-encoded original audio data to obtain a vector whose quantity of channels is 1 and whose dimension is 16,000; and the vector is inputted into the input layer 311, and after convolution processing, a feature vector whose quantity of channels is 32 and whose dimension is 16,000 may be obtained. In some implementations, to improve encoding efficiency, the encoder 310 may perform encoding processing on a batch of a quantity of B audio vectors at the same time.

In a down-sampling stage of the encoder, a first down-sampling layer reduces a vector dimension to ½, to obtain a feature vector whose quantity of channels is 64 and whose dimension is 8000; a second down-sampling layer reduces a vector dimension to ¼, to obtain a feature vector whose quantity of channels is 128 and whose dimension is 2000; a third down-sampling layer reduces a vector dimension to ⅕, to obtain a feature vector whose quantity of channels is 256 and whose dimension is 400; and a fourth down-sampling layer reduces a vector dimension to ¼, to obtain a feature vector whose quantity of channels is 512 and whose dimension is 50.

In an output stage of the encoder, the output layer 313 performs convolution processing on the feature vector to obtain an encoding vector whose quantity of channels is vq_dim and whose dimension is 25. vq_dim is a preset vector quantization dimension. For example, a value of vq_dim may be 32.

The encoding vector is inputted into a quantizer, and a vector index corresponding to each encoding vector may be obtained by querying a codebook. Then, the vector index may be transmitted to a data receive end, and the data receive end performs decoding processing on the vector index through the decoder 320 to obtain restored audio data.

In an embodiment of this application, the decoder 320 may include an input layer 321, one or more up-sampling layers 322, and an output layer 323.

After receiving the vector index transmitted by a network, the data receive end may first query the codebook through the quantizer for a codebook vector corresponding to the vector index. The codebook vector may be, for example, a vector whose quantity of channels is vq_dim and whose dimension is 25. vq_dim is a preset vector quantization dimension. For example, a value of vq_dim may be 32. In some implementations, to improve decoding efficiency, the data receive end may perform decoding processing on a batch of a quantity of B codebook vectors at the same time.

In an input stage of the decoder, a to-be-decoded codebook vector is inputted into the input layer 321, and after convolution processing, a feature vector whose quantity of channels is 512 and whose dimension is 50 may be obtained.

In an up-sampling stage of the decoder, a first up-sampling layer increases a vector dimension by 8 times (for example, 8×) to obtain a feature vector whose quantity of channels is 256 and whose dimension is 400; a second up-sampling layer increases a vector dimension by 5 times (for example, 5×) to obtain a feature vector whose quantity of channels is 128 and whose dimension is 2000; a third up-sampling layer increases a vector dimension by 4 times (for example, 4×) to obtain a feature vector whose quantity of channels is 64 and whose dimension is 8000; and a fourth up-sampling layer increases a vector dimension by 2 times (for example, 2×) to obtain a feature vector whose quantity of channels is 32 and whose dimension is 16,000.

In an output stage of the decoder, after the output layer 323 performs convolution processing on the feature vector, decoded audio data whose quantity of channels is 1 and whose dimension is 16,000 is restored.

The codec as a whole may be regarded as a speech-to-speech model. To make the speech generated by the model more consistent with a human hearing curve, in the embodiments of this application, Mel spectrums of an input audio and an output audio may be extracted separately and used as inputs of a loss function, so that the two are close to each other on the Mel spectrums. The Mel spectrum may be set to different sampling window sizes. To make the generated speech quality closer to an input speech, in the embodiments of this application, a multi-scale Mel spectrum constraint may be used as a reconstruction loss function.

The Mel spectrum is a spectrogram distributed under a mel scale, and the Mel spectrum may be represented as a Mel spectrum. A sound signal is originally a one-dimensional time domain signal, and it is difficult to see the frequency change pattern intuitively. If the sound signal is transformed into frequency domain through Fourier transform, although a frequency distribution of the signal can be seen, time domain information is lost and a change of the frequency distribution over time cannot be seen. In the embodiments of this application, time-frequency domain analysis methods such as short time Fourier transform, wavelet transform, and Wigner distribution may be used to resolve this problem.

STFT is to perform Fourier transform (FFT) on a short-time signal obtained by frame processing. Specifically, a long signal is framed and windowed, and then Fourier transform is performed on each frame. Finally, results of each frame are stacked along another dimension to obtain a two-dimensional signal form similar to a picture. When an original signal is an audio signal, the two-dimensional signal obtained by STFT expansion is a spectrogram. To obtain a voice feature of an appropriate size, the spectrogram is filtered and transformed through mel-scale filter banks to obtain the Mel spectrum.

The technical solutions such as the audio encoding method, the audio decoding method, the audio encoding apparatus, the audio decoding apparatus, the computer-readable medium, the electronic device, and the computer program product provided in this application are described below in detail with reference to specific embodiments from two aspects: a decoding side as the data receive end and an encoding side as the data transmit end.

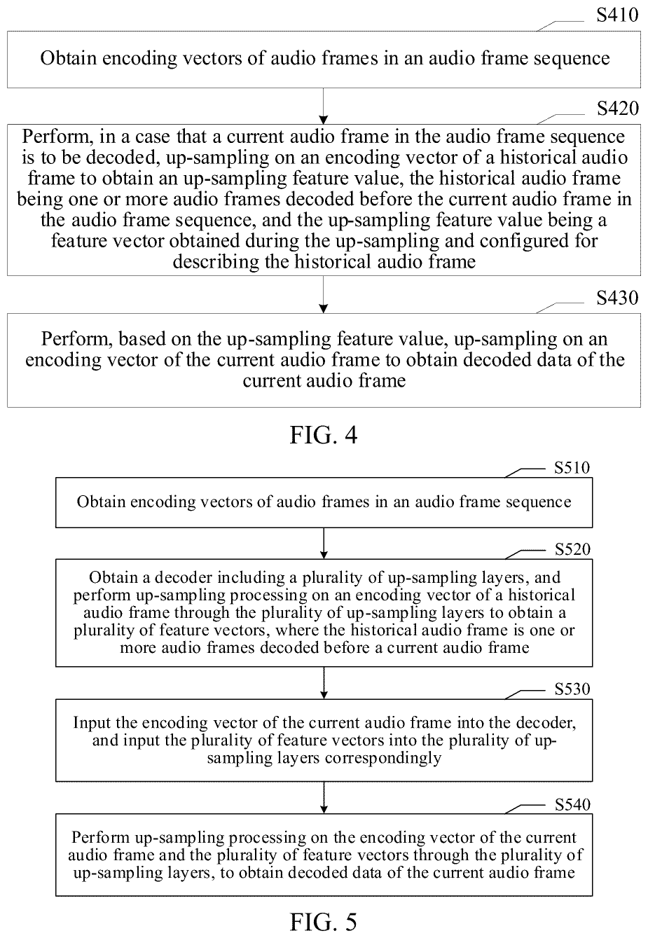

FIG. 4 is a flowchart of steps of an audio decoding method according to an embodiment of this application. The method may be executed by a terminal device or a server that receives encoded data, that is, an electronic device that executes the audio decoding method provided in the embodiments of this application may be a terminal device or a server. An example in which a terminal device executes the audio decoding method is used for description. The terminal device may be, for example, the audio and video decoding apparatus 210 shown in FIG. 2 or the decoder 320 shown in FIG. 3.

As shown in FIG. 4, an audio decoding method in this embodiment of this application may include the following S410 to S430.

S410: Obtain encoding vectors of audio frames in an audio frame sequence.

The audio frame is a data segment with a specified time length obtained by performing framing processing and windowing processing on the original audio data. The encoding vector is a data compression vector obtained by performing down-sampling on the audio frame for a plurality of times. In the embodiments of this application, the encoder constructed based on the convolutional neural network as shown in FIG. 3 may be used to encode the audio frame to obtain an encoding vector.

On the whole, a characteristic of the original audio data and a parameter representing an essential characteristic of the original audio data change with time, so that it is a non-stationary process and cannot be analyzed and processed by a digital signal processing technology that processes a stationary signal. However, since different speeches are responses generated by a movement of human oral muscles forming a certain shape of a vocal tract, and the movement of oral muscles is very slow relative to a frequency of speech. From another perspective, although the audio signal has a time-varying characteristic, within a short time range (for example, within a short time of 10 to 30 ms), the characteristic of the audio signal remains basically unchanged, that is, relatively stable. In this way, it may be regarded as a quasi-steady state process, that is, the audio signal has short-term stationarity. To implement the short-term analysis of the audio signal, in the embodiments of this application, the original audio data may be divided into segments to analyze characteristic parameters of the segments, where each segment is referred to as an audio frame. A frame length of the audio frame may be, for example, in a range of 10 to 30 ms. Frames may be divided into continuous segments or overlapping segments. The overlapping segments may make a smooth transition between frames and maintain continuity of the frames. An overlapping part between a previous frame and a next frame is referred to as a frame shift. A ratio of the frame shift to the frame length may be in a range of 0 to ½.

Windowing processing refers to performing function mapping on the framed audio signal by using a window function, so that two adjacent audio data frames can transition smoothly, a problem of signal discontinuity at the beginning and end of a data frame is reduced, and a higher global continuity is provided to avoid the Gibbs effect. In addition, through windowing processing, an audio signal that is originally non-periodic may also present some characteristics of a periodic function, which is beneficial to performing signal analysis and processing.

When performing windowing processing, slopes at both ends of a time window may be minimized, so that edges on both ends of the window smoothly transition to zero without causing a sharp change. In this way, the intercepted signal waveform may be reduced to zero and a truncation effect of an audio data frame may be reduced. A window length may be moderate. If the window length is very large, it is equivalent to a very narrow low-pass filter. When the audio signal passes through, a high-frequency part that reflects details of the waveform is blocked, and a short-term energy changes very little with time, which cannot truly reflect an amplitude change of the audio signal. On the contrary, if the window length is too short, a passband of the filter becomes wider, the short-term energy changes sharply with time, and a smooth energy function cannot be obtained.

In an embodiment of this application, a Hamming window may be selected as the window function. The Hamming window has a smooth low-pass characteristic and can reflect a frequency characteristic of the short-term signal to a high extent. In some other embodiments, other types of window functions such as a rectangular window and a Hanning window may also be selected.

S420: Perform, in a case that a current audio frame in the audio frame sequence is to be decoded, up-sampling on an encoding vector of a historical audio frame to obtain an up-sampling feature value, the historical audio frame being one or more audio frames decoded before the current audio frame in the audio frame sequence, and the up-sampling feature value being a feature vector obtained during the up-sampling and configured for describing the historical audio frame.

In an embodiment of this application, the historical audio frame is one or more audio frames that are temporally continuous with the current audio frame in the audio frame sequence. For example, a current audio frame that is being decoded is an N^{th} audio frame in the audio frame sequence, and a corresponding historical audio frame may be an (N−1)^{th} audio frame in the audio frame sequence.

Up-sampling is an operation that performs mapping processing on encoding vectors from a low dimension to a high dimension. For example, up-sampling methods such as linear interpolation, deconvolution, or unpooling may be used. Linear interpolation is a method of inserting a new element into a low-dimensional vector to obtain a high-dimensional vector based on a linear interpolation function, and may include a nearest neighbor interpolation algorithm, bilinear interpolation algorithm, bicubic interpolation algorithm, and the like. Deconvolution, also referred to as transposed convolution, is a special convolution operation. For example, 0 may be first added to the low-dimensional vector to expand a vector dimension, and then forward convolution is performed through a convolution kernel to obtain the high-dimensional vector. Unpooling is a reverse operation of pooling.

In an embodiment of this application, up-sampling process data may be retained by configuring a buffer region. When an audio frame is performed up-sampling, a feature vector for describing the audio frame obtained during up-sampling may be cached, for example, the up-sampling feature value of the historical audio frame.

S430: Perform, based on the up-sampling feature value, up-sampling on an encoding vector of the current audio frame to obtain decoded data of the current audio frame.

In an embodiment of this application, the up-sampling feature value of the historical audio frame and the encoding vector of the current audio frame may be inputted into the decoder as input data, so that the decoder can perform up-sampling on the current audio frame by using a feature vector of the historical audio frame.

The original audio data lose some information during encoding, and the original audio data is generally difficult to be restored based on the up-sampling decoding process. In the embodiments of this application, an up-sampling process of the current audio frame may be guided by caching an up-sampling feature of a previously decoded historical audio frame to improve a data restoration effect of audio decoding, so that the audio encoding and decoding quality can be improved.

FIG. 5 is a flowchart of steps of performing an audio decoding method based on a convolutional neural network including a plurality of up-sampling layers according to an embodiment of this application. As shown in FIG. 5, the audio decoding method may include the following S510 to S540.

S510: Obtain encoding vectors of audio frames in an audio frame sequence.

The audio frame is a data segment with a specified time length obtained by performing framing processing and windowing processing on the original audio data. The encoding vector is a data compression vector obtained by performing down-sampling on the audio frame for a plurality of times. In the embodiments of this application, the encoder constructed based on the convolutional neural network as shown in FIG. 3 may be used to encode the audio frame to obtain an encoding vector.

S520: Obtain a decoder including a plurality of up-sampling layers, and perform up-sampling processing on an encoding vector of a historical audio frame through the plurality of up-sampling layers to obtain a plurality of feature vectors, where the historical audio frame is one or more audio frames decoded before a current audio frame.

In the embodiments of this application, the decoder constructed based on the convolutional neural network as shown in FIG. 3 may be used to perform decoding processing on the encoding vector of the audio frame. The decoder includes a plurality of sequentially connected up-sampling layers, and each of the plurality of up-sampling layers may implement up-sampling processing by performing convolution operation on the input vector.

In the embodiments of this application, after the decoder performs up-sampling processing on the encoding vector of the historical audio frame, a plurality of feature vectors with a same quantity of the up-sampling layers may be obtained. In this case, the plurality of feature vectors may be used as the up-sampling feature value. For example, the decoder shown in FIG. 3 includes four up-sampling layers, each of the up-sampling layers outputs a feature vector, and up-sampling processing is performed on a historical audio frame to obtain four feature vectors.

In some implementations, after the decoder performs up-sampling processing on the encoding vector of the historical audio frame, a plurality of feature vectors that a quantity of the feature vectors is smaller than that of the up-sampling layers may be obtained. For example, the decoder shown in FIG. 3 includes four up-sampling layers, each of the up-sampling layers outputs a feature vector, and then a part of feature vectors are extracted from the up-sampling layers. That is, up-sampling processing is performed on a historical audio frame to obtain a quantity of feature vectors that is less than four.

S530: Input the encoding vector of the current audio frame into the decoder, and input the plurality of feature vectors into the plurality of up-sampling layers correspondingly.

The encoding vector of the current audio frame is performed up-sampling for a plurality of times through the plurality of up-sampling layers of the encoder. During performing up-sampling processing on the encoding vector of the current audio frame, the plurality of feature vectors obtained by performing up-sampling on the historical audio frame are synchronously inputted into the up-sampling layers. That is, the input data of the up-sampling layer in the encoder, in addition to the output data of the previous up-sampling layer, also includes feature vectors obtained by performing up-sampling processing on the historical audio frame.

S540: Perform up-sampling processing on the encoding vector of the current audio frame and the plurality of feature vectors through the plurality of up-sampling layers, to obtain the decoded data of the current audio frame.

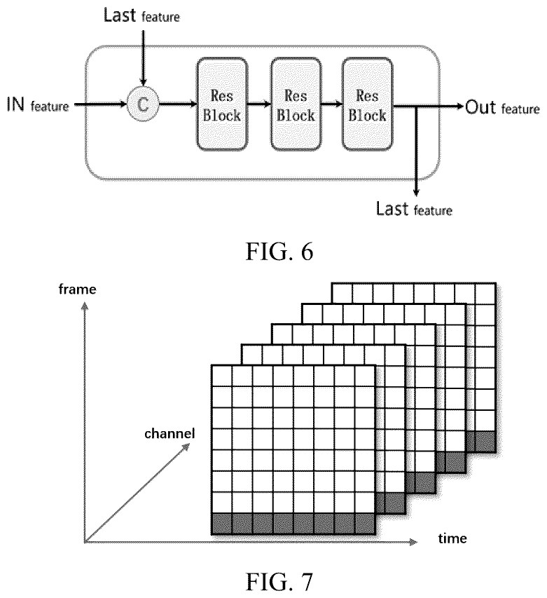

FIG. 6 is a schematic diagram of a network module implementing data encoding and decoding processing according to an embodiment of this application. The network module shown in FIG. 6 is a basic functional module that constitutes the encoder or decoder shown in FIG. 3. For example, each of the down-sampling layers in the encoder or each of the up-sampling layers in the decoder may include one or more network modules shown in FIG. 6.

As shown in FIG. 6, the network module that implements data encoding and decoding processing includes a plurality of residual blocks Res Blocks. The input data of the network module includes two parts, namely a current input feature In feature and a first historical feature Last feature. The current input feature In feature may be an output feature obtained by performing convolution processing on the current audio frame by a previous network module, and the historical feature Last feature may be an output feature obtained by performing convolution processing on a previous audio frame by the current network module, for example, may be the up-sampling feature value obtained by performing up-sampling processing on the encoding vector of the historical audio frame through the up-sampling layer in the foregoing embodiments of this application.

The output data of the network module also includes two parts, namely a current output feature Out feature and a second historical feature Last feature. The current output feature Out feature may be used as an output feature obtained by performing convolution processing on the current audio frame by a next network module, and the second historical feature Last feature may be used as an input feature obtained by performing convolution processing on the next audio frame by the current network module.

In the embodiments of this application, by retaining the output feature of the previous audio frame, the up-sampling feature value obtained during performing up-sampling processing on the historical audio frame may be jointly decoded with the encoding vector of the current audio frame, so that an input receptive field of the current audio frame can be improved and the accuracy of audio encoding and decoding can be improved.

In an embodiment of this application, the up-sampling layer of the decoder includes at least two sampling channels. On this basis, in S540, a method of performing up-sampling processing on the encoding vector of the current audio frame and the plurality of feature vectors through the plurality of up-sampling layers may include: performing feature extraction on the encoding vector of the current audio frame and the plurality of feature vectors through the at least two sampling channels in the up-sampling layer, to obtain at least two channel feature values; obtaining an average value and a variance of the at least two channel feature values; and performing normalization processing on the at least two channel feature values based on the average value and the variance.

Different sampling channels may perform convolution processing on the input data based on convolution kernels of different sizes or different parameters to obtain a plurality of channel feature values under different representation dimensions, which can improve the comprehensiveness and reliability of feature extraction from the audio frame. On this basis, to reduce amount of model calculation, in the embodiments of this application, normalization processing may be performed on channel feature values acquired on different sampling channels for a same audio frame.

FIG. 7 is a schematic diagram showing a principle of performing normalization processing on channel feature values outputted by a plurality of sampling channels according to an embodiment of this application. Each square in FIG. 7 represents a data sampling point, a row of squares distributed in a horizontal direction represents an audio frame, multi-row squares distributed in a vertical direction represent a plurality of audio frames that are encoded and decoded simultaneously in a batch, and multi-row squares distributed in a depth direction represent a plurality of sampling channels that performs sampling on a same audio frame.

As shown in FIG. 7, when performing normalization processing on mapping data of the data sampling point, an audio frame is used as a normalization unit, and the audio frames are independent of each other. First, an average value and a variance may be calculated for a plurality of channel feature values obtained by performing sampling on different sampling channels in the same audio frame, and then the average value is subtracted from each of the channel feature values and divided by the variance to obtain the normalized channel feature value. By performing normalization processing on the plurality of channel feature values obtained by performing sampling on different sampling channels for each of the audio frames, the sampling channels can share a same average value and variance, ensuring the comprehensiveness of data sampling while reducing the amount of data calculation.

In an embodiment of this application, before performing normalization processing on at least two channel feature values based on an average value and a variance, weighted smoothing processing may be performed on the average values and variances between audio frames. In this case, a manner of performing normalization processing on the at least two channel feature values may be performing normalization processing on the at least two channel feature values based on the average value and the variance after performing weighted smoothing processing to further reduce the amount of data calculation.

When audio data is transmitted, real-time segmented transmission may be used. The characteristics of real-time segmented transmission determine that a user can obtain media data in real time in a case that there is no need to download a complete media file, but at the same time, also put forward high requirements on device performance of the user and a network condition. In a case that a network status is not ideal, to ensure the transmission efficiency of the audio frame, the audio frame may be compressed and quantized to obtain an index value. In this way, the quantized index value is transmitted during transmission, thereby reducing the amount of data transmission and improving data transmission efficiency. In this case, when decoding, a corresponding encoding vector may be found from the codebook through the index value, and then the decoding is completed.

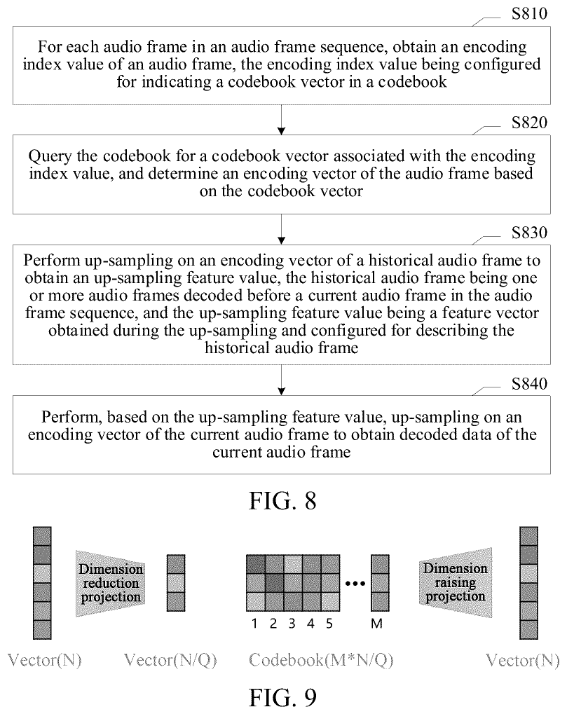

FIG. 8 is a flowchart of steps of performing audio frame decoding processing based on querying a codebook according to an embodiment of this application. By configuring a same codebook in the encoder and decoder, the encoding vector of the audio frame may be positioned based on a manner of querying the codebook, which reduces the amount of data transmission on an encoding and decoding side. As shown in FIG. 8, a method of performing decoding processing on the encoding vector of the audio frame based on querying the codebook may include the following S810 to S840.

S810: For each audio frame in the audio frame sequence, obtain an encoding index value of the audio frame, the encoding index value being configured for indicating a codebook vector in a codebook.

The codebook is configured for saving a mapping relationship between the encoding index value and the codebook vector. A transmitting party of audio data may transfer encoding index values of audio frames to a receiver through network transmission, which can greatly reduce the amount of data transmission and significantly improve the transmission efficiency of the audio data.

S820: Query the codebook for a codebook vector associated with the encoding index value, and determine an encoding vector of the audio frame based on the codebook vector.

After the receiver of the audio data obtains the encoding index value, the codebook may be queried by using the quantizer to obtain the codebook vector associated with the encoding index value, and the encoding vector of the audio frame may be further determined based on the codebook vector.

In some implementations, the decoder may directly use the codebook vector obtained by querying the codebook as the encoding vector of the audio frame, or may perform data mapping on the obtained codebook vector based on a preset mapping rule to determine the encoding vector of the audio frame. The preset mapping rule may be a pre-agreed rule between the transmitting party and the receiver of the audio data. Using data mapping to determine the encoding vector can improve the security of data transmission while sharing the codebook.

In an embodiment of this application, a dimension of the codebook vector is lower than a dimension of the encoding vector; and a method of determining the encoding vector of the audio frame based on the codebook vector includes: performing dimension raising projection on the codebook vector to obtain the encoding vector of the audio frame. In the embodiments of this application, using dimension raising projection for data mapping can reduce the vector dimension in the codebook, compress the codebook, and reduce the amount of maintenance data of the codebook.

FIG. 9 is a schematic diagram showing a principle of determining an encoding vector based on data mapping according to an embodiment of this application. As shown in FIG. 9, on an encoding side, after the encoder performs data encoding on the audio frame, an encoding vector may be obtained, and a dimension of the vector is, for example, N. Before the codebook is queried, the encoding vector is first performed dimension reduction projection to compress a vector with a dimension of N/Q. Correspondingly, the codebook includes M codebook vectors, where a vector dimension of each of the codebook vectors is N/Q. By querying the codebook, an encoding index value corresponding to the encoding vector may be determined. The encoding index value ranges from 1 to M.

On a decoding side, after the encoding index value transmitted by a data transmitting party is received, the codebook may be queried first to obtain the codebook vector corresponding to the encoding index value. The vector dimension of the codebook vector is N/Q. After dimension raising projection is performed on the codebook vector, the encoding vector with vector dimension N may be restored.

In an embodiment of this application, the encoding vector may be performed dimension reduction projection or dimension raising projection based on linear transformation, or some network layers of neural networks such as a convolutional layer and a full connected layer may be used for data mapping.

S830: Perform up-sampling on an encoding vector of a historical audio frame to obtain an up-sampling feature value, the historical audio frame being one or more audio frames decoded before the current audio frame in the audio frame sequence, and the up-sampling feature value being a feature vector obtained during the up-sampling and configured for describing the historical audio frame.

The historical audio frame is one or more audio frames that are temporally continuous with the current audio frame in the audio frame sequence. For example, a current audio frame that is being decoded is an N^{th} audio frame in the audio frame sequence, and a corresponding historical audio frame may be an (N−1)^{th} audio frame in the audio frame sequence.

Up-sampling is an operation that performs mapping processing on encoding vectors from a low dimension to a high dimension. For example, up-sampling methods such as linear interpolation, deconvolution, or unpooling may be used. In the embodiments of this application, up-sampling process data may be retained by configuring a buffer region. When an audio frame is performed up-sampling, a feature vector for describing the audio frame obtained during up-sampling may be cached.

S840: Perform, based on the up-sampling feature value, up-sampling on an encoding vector of the current audio frame to obtain decoded data of the current audio frame.

In the embodiments of this application, the up-sampling feature value of the historical audio frame and the encoding vector of the current audio frame may be inputted into the decoder as input data, so that the decoder can perform up-sampling on the current audio frame by using the up-sampling feature value of the historical audio frame. The original audio data lose some information during encoding, and the original audio data is generally difficult to be restored based on the up-sampling decoding process. In the embodiments of this application, an up-sampling process of the current audio frame may be guided by caching an up-sampling feature of a previously decoded historical audio frame to improve a data restoration effect of audio decoding, so that the audio encoding and decoding quality can be improved.

To ensure the stability and reliability of data encoding and decoding, the codebook may be queried through the quantizer in an encoding and decoding model, and the codebook may be updated based on sample data. The quantizer in the embodiments of this application may be a model constructed based on a convolutional neural network, and the quantizer may be trained based on the sample data to improve an encoding and quantization effect on the audio frame.

In an embodiment of this application, a method of training a quantizer may include: obtaining the codebook and a quantizer configured to maintain the codebook, the codebook being configured for representing a mapping relationship between the encoding index value and the codebook vector; obtaining an encoding vector sample obtained by performing encoding processing on an audio frame sample by the encoder; predicting a codebook vector sample matching the encoding vector sample through the quantizer; and updating a network parameter of the quantizer based on a loss error between the encoding vector sample and the codebook vector sample, so that training of the quantizer is implemented. After the quantizer is trained, the codebook may be queried through the trained quantizer to obtain the codebook vector associated with the encoding index value.

In an embodiment of this application, a method of maintaining and updating the codebook based on the quantizer may include: obtaining a statistical parameter of the encoding vector sample matching the codebook vector sample; and updating the codebook based on the statistical parameter, the updated codebook being configured for predicting the codebook vector sample matching the encoding vector sample next time. By continuously updating the codebook, the encoding and quantization effect of the audio frame for the codebook may be improved.

In an embodiment of this application, the statistical parameter of the encoding vector sample includes at least one of a vector sum or a quantity of hits, the vector sum being configured for representing an average value vector obtained by performing weighted average processing on encoding vector samples, the quantity of hits representing a quantity of encoding vector samples matching the codebook vector sample. On this basis, a method of updating the codebook based on the statistical parameter may include: performing exponential weighted smoothing on the codebook based on a vector sum; and performing Laplacian smoothing on the codebook based on the quantity of hits.

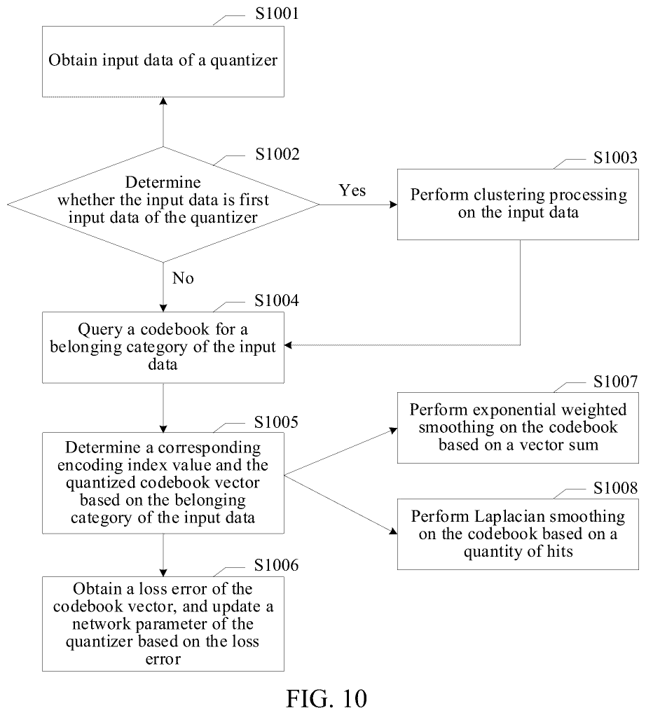

FIG. 10 is a flowchart of steps of training a quantizer according to an embodiment of this application. As shown in FIG. 10, in the embodiments of this application, the construction and maintenance of the codebook may be implemented based on training of the quantizer. A training process includes the following S1001 to S1006.

S1001: Obtain input data of the quantizer, and the input data is an encoding vector sample obtained by performing encoding processing on audio data (such as audio data of an audio frame sample).

S1002: Determine whether the input data is first input data of the quantizer. If the input data is inputted to the quantizer for a first time, S1003 is performed; or if the input data is not inputted to the quantizer for a first time, S1004 is performed.

S1003: Perform clustering processing on the input data to obtain M clusters, where each cluster corresponds to a codebook vector. M codebook vectors may form a codebook for data quantization, and the codebook stores an encoding index value corresponding to each codebook vector.

In an implementation, in the embodiments of this application, the clustering processing may be performed on the input data based on K-means clustering, and each cluster corresponds to a codebook vector and an encoding index value. In addition, a vector sum of vectors in each cluster and a quantity of hits for vector query for each cluster may be counted.

S1004: Query a codebook for a belonging category of the input data.

A manner of searching for the belonging category may include predicting the similarity between the input data and cluster centers of clusters, and using a cluster with a highest similarity as the belonging category of the input data.

S1005: Determine a corresponding encoding index value and the quantized codebook vector based on the belonging category of the input data.

S1006: Obtain a loss error of the codebook vector, and update a network parameter of the quantizer based on the loss error. The loss error of the codebook vector may be, for example, a mean square error loss (MSE Loss). A mean square error refers to an expected value of a square of a difference between a parameter estimate value and a parameter value. The mean square error loss may evaluate a degree of change in the data. A smaller mean square error loss indicates that the accuracy of the quantizer in quantizing the input data is better.

S1007: Perform exponential weighted smoothing on the codebook based on a vector sum. EMA smoothing, that is, exponential moving average, may be regarded as an average value of a variable in a past period. Compared with direct assignment of the variable, a value obtained by performing moving average is flatter and smoother in data distribution and has less jitter. A moving average value is not fluctuant greatly due to a certain abnormal value.

S1008: Perform Laplacian smoothing on the codebook based on the quantity of hits. A zero probability problem that occurs in a vector prediction of the codebook may be resolved by Laplacian smoothing.

In the embodiments of this application, by performing weighted smoothing on the codebook, the codebook may be continuously updated, so that the vector generated by the encoder closer to the vector in the codebook, thereby improving the prediction accuracy of the quantizer for the vector in the codebook.

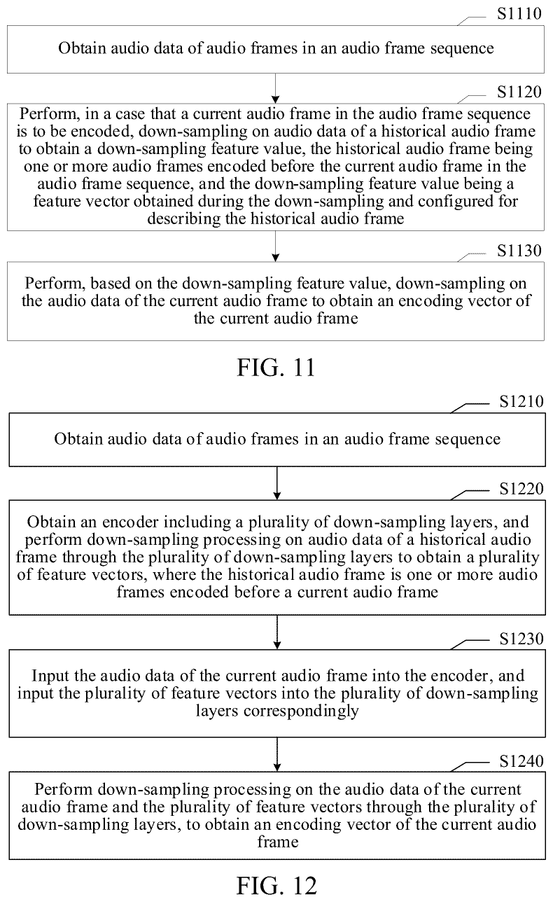

FIG. 11 is a flowchart of steps of an audio encoding method according to an embodiment of this application. The method may be executed by a terminal device or a server that transmits audio data. An example in which a terminal device executes the audio encoding method is used for description. The terminal device may be, for example, the audio and video encoding apparatus 203 shown in FIG. 2 or the encoder 310 shown in FIG. 3.

As shown in FIG. 11, an audio decoding method in this embodiment of this application may include the following S1110 to S1130.

S1110: Obtain audio data of audio frames in an audio frame sequence.

The audio frame is a data segment with a specified time length obtained by performing framing processing and windowing processing on the original audio data.

On the whole, a characteristic of the original audio data and a parameter representing an essential characteristic of the original audio data change with time, so that it is a non-stationary process and cannot be analyzed and processed by a digital signal processing technology that processes a stationary signal. However, since different speeches are responses generated by a movement of human oral muscles forming a certain shape of a vocal tract, and the movement of oral muscles is very slow relative to a frequency of speech. From another perspective, although the audio signal has a time-varying characteristic, within a short time range (for example, within a short time of 10 to 30 ms), the characteristic of the audio signal remains basically unchanged, that is, relatively stable. In this way, it may be regarded as a quasi-steady state process, that is, the audio signal has short-term stationarity. To implement the short-term analysis of the audio signal, in the embodiments of this application, the original audio data may be divided into segments to analyze characteristic parameters of the segments, where each segment is referred to as an audio frame. A frame length of the audio frame may be, for example, in a range of 10 to 30 ms. Frames may be divided into continuous segments or overlapping segments. The overlapping segments may make a smooth transition between frames and maintain continuity of the frames. An overlapping part between a previous frame and a next frame is referred to as a frame shift. A ratio of the frame shift to the frame length may be in a range of 0 to ½.

Windowing processing refers to performing function mapping on the framed audio signal by using a window function, so that two adjacent audio data frames can transition smoothly, a problem of signal discontinuity at the beginning and end of a data frame is reduced, and a higher global continuity is provided to avoid the Gibbs effect. In addition, through windowing processing, an audio signal that is originally non-periodic may also present some characteristics of a periodic function, which is beneficial to performing signal analysis and processing.

S1120: Perform, in a case that a current audio frame in the audio frame sequence is to be encoded, down-sampling on audio data of a historical audio frame to obtain a down-sampling feature value, the historical audio frame being one or more audio frames encoded before the current audio frame in the audio frame sequence, and the down-sampling feature value being a feature vector obtained during the down-sampling and configured for describing the historical audio frame.

In an embodiment of this application, the historical audio frame is one or more audio frames that are temporally continuous with the current audio frame in the audio frame sequence. For example, a current audio frame that is being decoded is an N^{th} audio frame in the audio frame sequence, and a corresponding historical audio frame may be an (N−1)^{th} audio frame in the audio frame sequence.

Down-sampling is an operation that performs mapping processing on encoding vectors from a high dimension to a low dimension. For example, down-sampling may be performed by a convolution operation or a pooling operation.

In an embodiment of this application, down-sampling process data may be retained by configuring a buffer region. When an audio frame is performed down-sampling, a feature vector for describing the audio frame obtained during down-sampling may be cached.

S1130: Perform, based on the down-sampling feature value, down-sampling on the audio data of the current audio frame to obtain an encoding vector of the current audio frame.

In an embodiment of this application, the down-sampling feature value of the historical audio frame and the audio data of the current audio frame may be inputted into the encoder as input data, so that the encoder can perform down-sampling on the current audio frame by using a feature of the historical audio frame.

The original audio data lose some information during encoding. In the embodiments of this application, a down-sampling process of the current audio frame may be guided by caching a down-sampling feature of a previously encoded historical audio frame to improve data correlation of audio encoding, and the audio encoding and decoding quality is improved.

FIG. 12 is a flowchart of steps of performing an audio encoding method based on a convolutional neural network including a plurality of down-sampling layers according to an embodiment of this application. As shown in FIG. 12, the audio encoding method may include the following S1210 to S1240.

S1210: Obtain audio data of audio frames in an audio frame sequence.

The audio frame is a data segment with a specified time length obtained by performing framing processing and windowing processing on the original audio data. The encoding vector is a data compression vector obtained by performing down-sampling on the audio frame for a plurality of times. In the embodiments of this application, the encoder constructed based on the convolutional neural network as shown in FIG. 3 may be used to encode the audio frame to obtain an encoding vector.

S1220: Obtain an encoder including a plurality of down-sampling layers, and perform down-sampling processing on audio data of a historical audio frame through the plurality of down-sampling layers to obtain a plurality of feature vectors, where the historical audio frame is one or more audio frames encoded before a current audio frame.

In the embodiments of this application, the encoder constructed based on the convolutional neural network as shown in FIG. 3 may be used to perform encoding processing on the audio data of the audio frame. The encoder includes a plurality of sequentially connected down-sampling layers, and each of the plurality of down-sampling layers may implement down-sampling processing by performing convolution operation on the input vector.

In the embodiments of this application, after the encoder performs down-sampling processing on the audio data of the historical audio frame, a plurality of feature vectors with a same quantity of the down-sampling layers may be obtained. For example, the encoder shown in FIG. 3 includes four down-sampling layers, each of the down-sampling layers outputs a feature vector, and down-sampling processing is performed on a historical audio frame to obtain four feature vectors.

In some implementations, after the encoder performs down-sampling processing on the audio data of the historical audio frame, a plurality of feature vectors that a quantity of the feature vectors is smaller than that of the down-sampling layers may be obtained. For example, the encoder shown in FIG. 3 includes four down-sampling layers, each of the down-sampling layers outputs a feature vector, and then a part of feature vectors are extracted from the down-sampling layers. That is, down-sampling processing is performed on a historical audio frame to obtain a quantity of feature vectors that is less than four.

S1230: Input the audio data of the current audio frame into the encoder, and input the plurality of feature vectors into the plurality of down-sampling layers correspondingly.

The audio data of the current audio frame is performed down-sampling for a plurality of times through the plurality of down-sampling layers of the encoder. During performing down-sampling processing on the audio data of the current audio frame, the plurality of feature vectors obtained by performing down-sampling on the historical audio frame are synchronously inputted into the down-sampling layers. That is, the input data of the down-sampling layer in the encoder, in addition to the output data of the previous down-sampling layer, also includes feature vectors obtained by performing down-sampling processing on the historical audio frame.

S1240: Perform down-sampling processing on the audio data of the current audio frame and the plurality of feature vectors through the plurality of down-sampling layers, to obtain an encoding vector of the current audio frame.

In the embodiments of this application, by retaining the output feature of the previous audio frame, the feature vector obtained during performing down-sampling processing on the historical audio frame may be jointly encoded with the audio data of the current audio frame, so that an input receptive field of the current audio frame can be improved and the accuracy of audio encoding and decoding can be improved.

In an embodiment of this application, the down-sampling layer of the encoder includes at least two sampling channels. On this basis, in S1240, a method of performing down-sampling processing on the audio data of the current audio frame and the plurality of feature vectors through the plurality of down-sampling layers may include: performing feature extraction on the audio data of the current audio frame and the plurality of feature vectors through the at least two sampling channels in the plurality of down-sampling layers, to obtain at least channel feature values; obtaining an average value and a variance of the at least two channel feature values; and performing normalization processing on the at least two channel feature values based on the average value and the variance.

Different sampling channels may perform convolution processing on the input data based on convolution kernels of different sizes or different parameters to obtain a plurality of channel feature values under different representation dimensions, which can improve the comprehensiveness and reliability of feature extraction from the audio frame. On this basis, to reduce amount of model calculation, in the embodiments of this application, normalization processing may be performed on channel feature values acquired on different sampling channels for a same audio frame. For a solution of perform normalization processing on channel feature values acquired on different sampling channels, reference may be made to an embodiment shown in FIG. 7, and details are not described herein again.

In an embodiment of this application, audio frame encoding processing may be performed based on querying a codebook. By configuring a same codebook in the encoder and decoder, the encoding vector of the audio frame may be positioned based on a manner of querying the codebook, which reduces the amount of data transmission on an encoding and decoding side. In the embodiments of this application, after the encoding vector is obtained, the codebook vector may be obtained by querying the codebook based on the encoding vector, and the encoding index value associated with the codebook vector may be obtained.

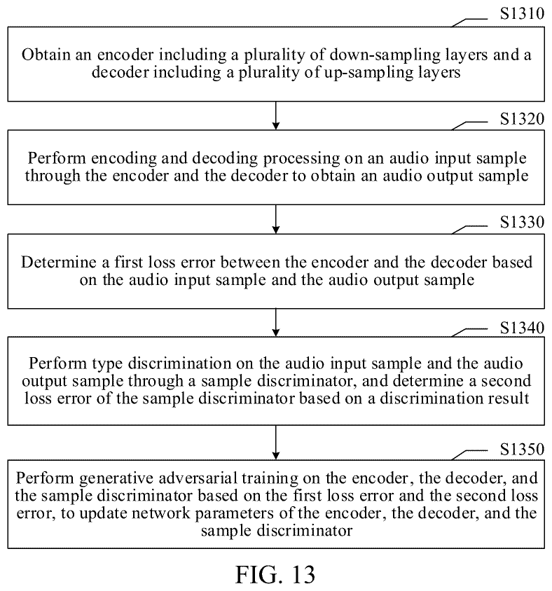

FIG. 13 is a flowchart of steps of performing model training for an encoder and a decoder according to an embodiment of this application. As shown in FIG. 13, in the embodiments of this application, a model training of an encoder and a decoder may be implemented by constructing a generative adversarial network. A training method may include the following S1310 to S1350.

S1310: Obtain an encoder including a plurality of down-sampling layers and a decoder including a plurality of up-sampling layers.

The encoder and the decoder in the embodiments of this application may be the encoding and decoding model constructed based on the convolutional neural network as shown in FIG. 3, where each of the plurality of up-sampling layers or each of the plurality of down-sampling layers may use a convolution operation or a causal convolution operation to perform feature mapping.

S1320: Perform encoding and decoding processing on an audio input sample through the encoder and the decoder to obtain an audio output sample.

The encoder performs encoding processing on the audio input sample to obtain a corresponding encoding vector sample, and then the decoder performs decoding processing on the encoding vector sample to obtain the audio output sample. A method of performing encoding and decoding processing by the encoder and decoder may refer to the foregoing embodiments and details are not described herein again.

S1330: Determine a first loss error between the encoder and the decoder based on the audio input sample and the audio output sample.

In an embodiment of this application, spectral feature extraction is performed on the audio input sample and the audio output sample respectively, that is, spectral feature extraction is performed on the audio input sample to obtain a first Mel spectrum, and spectral feature extraction is performed on the audio output sample to obtain a second Mel spectrum, and then a first loss error between the encoder and the decoder is determined based on a difference between the first Mel spectrum and the second Mel spectrum.

In an embodiment of this application, a manner of performing spectral feature extraction on the audio input sample to obtain a first Mel spectrum, and performing spectral feature extraction on the audio output sample to obtain a second Mel spectrum may be that: obtaining a sampling window including at least two sample scales; and performing spectral feature extraction on the audio input sample at different sample scales through the sampling window to obtain a multi-scale first Mel spectrum, and performing spectral feature extraction on the audio output sample to obtain a multi-scale second Mel spectrum.

S1340: Perform type discrimination on the audio input sample and the audio output sample through a sample discriminator, and determine a second loss error of the sample discriminator based on a discrimination result.

S1350: Perform generative adversarial training on the encoder, the decoder, and the sample discriminator based on the first loss error and the second loss error, to update network parameters of the encoder, the decoder, and the sample discriminator.

In an embodiment of this application, the sample discriminator may include an original sample discriminator and a sample feature discriminator; and the performing type discrimination on the audio input sample and the audio output sample through the sample discriminator includes: inputting the audio input sample and the audio output sample into the original sample discriminator to obtain a first-type discrimination result outputted by the original sample discriminator; performing spectral feature extraction on the audio input sample to obtain a first Mel spectrum, and performing spectral feature extraction on the audio output sample to obtain a second Mel spectrum; and inputting the first Mel spectrum and the second Mel spectrum into the sample feature discriminator to obtain a second-type discrimination result outputted by the sample feature discriminator. In this case, the discrimination result includes the first-type discrimination result and the second-type discrimination result.

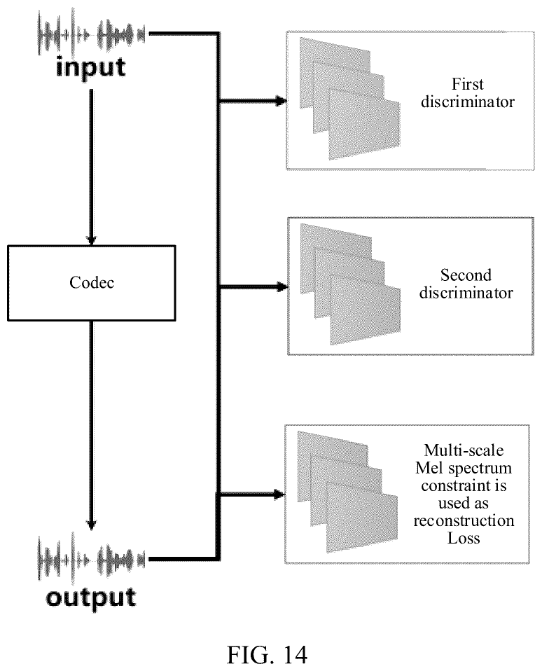

FIG. 14 is a schematic diagram showing a principle of performing encoding and decoding model training based on a generative adversarial network according to an embodiment of this application. As shown in FIG. 14, the codec as a whole may be regarded as a speech-to-speech model. To make the speech generated by the model more consistent with a human hearing curve, Mel spectrums of an input audio input and an output audio output may be extracted separately and used as inputs of a loss function, so that the two are close to each other on the Mel spectrums. The Mel spectrum may be set to different sampling window sizes. To make the generated speech quality closer to an input speech, in the embodiments of this application, a multi-scale Mel spectrum constraint is used as a reconstruction loss.

In the embodiments of this application, model training is performed by using a generative adversarial network (GAN), the codec is used as a generator, and two discriminators are designed at the same time: the original speech is used as input to the discriminator (for example, a first discriminator in FIG. 14) and the Mel spectrum is used as the input to the discriminator (for example, a second discriminator in FIG. 14). Data discrimination is performed by using two discriminators from two perspectives of audio sampling and Mel spectrum sampling, which can improve the strength of data discrimination, thereby improving the encoding and decoding quality of the audio data by the encoding and decoding model.

Encoding or decoding processing is performed on the audio data by using the encoding and decoding model provided in the foregoing embodiments of this application, which can significantly improve the encoding and decoding quality of the audio data, especially in weak network environments, such as in an elevator, under a tall building, and in a mountainous region, call quality of a speech call and a video call is improved.

Table 1 shows a call quality comparison result between a codec model in the embodiments of this application and a codec model in related art. Both PESQ and STOI indicators are configured for measuring speech quality, and a larger value indicates a better speech quality.

TABLE 1

| Encoding and decoding model | PESQ ↑ | STOI ↑ |
|---|---|---|
| Opus (3 kbps) | 1.11104 | 0.75153 |
| Opus (6 kbps) | 1.71769 | 0.89403 |
| Lyra (3 kbps) | 1.69770 | 0.83564 |
| This application (3 kbps) | 2.84581 | 0.94028 |

It may be seen from a comparison result in Table 1 that, the codec model provided in the embodiments of this application may provide a smooth speech call at a bandwidth of 3 kbps, and the call quality is higher than the call quality of an open source codec Opus at a bandwidth of 6 kbps.

Although the steps of the method in this application are described in a specific order in the accompanying drawings, this does not require or imply that the steps have to be performed in the specific order, or all the steps shown have to be performed to achieve an expected result. Additionally or alternatively, some steps may be omitted, a plurality of steps may be combined into one step, and/or one step may be decomposed into a plurality of steps for execution, and the like.

The following describes the apparatus embodiments of this application, which may be configured to perform the audio encoding and decoding method in the foregoing embodiments of this application.

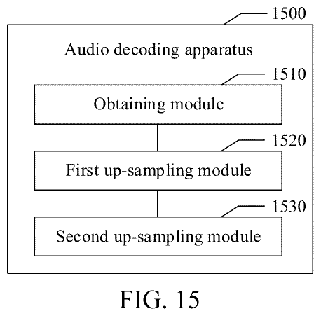

FIG. 15 is a structural block diagram of an audio decoding apparatus according to an embodiment of this application. As shown in FIG. 15, the audio decoding apparatus 1500 includes:
an obtaining module 1510, configured to obtain encoding vectors of audio frames in an audio frame sequence;
a first up-sampling module 1520, configured to perform, in a case that a current audio frame in the audio frame sequence is decoded, up-sampling on an encoding vector of a historical audio frame to obtain an up-sampling feature value, the historical audio frame being one or more audio frames decoded before the current audio frame in the audio frame sequence, and the up-sampling feature value being a feature vector obtained during the up-sampling and configured for describing the historical audio frame; and
a second up-sampling module 1530, configured to perform up-sampling, based on the up-sampling feature value, on an encoding vector of the current audio frame to obtain decoded data of the current audio frame.

In an embodiment of this application, the second up-sampling module 1530 may further include:
a decoder obtaining module, configured to obtain a decoder including a plurality of up-sampling layers, the up-sampling feature value including a plurality of feature vectors obtained through performing up-sampling processing on the encoding vector of the historical audio frame through the plurality of up-sampling layers respectively;
a data input module, configured to input the encoding vector of the current audio frame into the decoder, and input the plurality of feature vectors into the plurality of up-sampling layers correspondingly; and
an up-sampling processing module, configured to perform up-sampling processing on the encoding vector of the current audio frame and the plurality of feature vectors through the plurality of up-sampling layers, to obtain the decoded data of the current audio frame.

In an embodiment of this application, the second up-sampling module 1530 may further include:
an encoder obtaining module, configured to obtain an encoder including a plurality of down-sampling layers;
an encoder processing module, configured to perform encoding and decoding processing on an audio input sample through the encoder and the decoder to obtain an audio output sample;
a first error determining module, configured to determine a first loss error between the encoder and the decoder based on the audio input sample and the audio output sample;
a second error determining module, configured to perform type discrimination on the audio input sample and the audio output sample through a sample discriminator, and determine a second loss error of the sample discriminator based on a discrimination result; and
a generative adversarial training module, configured to perform generative adversarial training on the encoder, the decoder, and the sample discriminator based on the first loss error and the second loss error, to update network parameters of the encoder, the decoder, and the sample discriminator.

In an embodiment of this application, the sample discriminator includes an original sample discriminator and a sample feature discriminator; and a second error determining module includes:
a discriminator input module, configured to input the audio input sample and the audio output sample into the original sample discriminator to obtain a first-type discrimination result outputted by the original sample discriminator;
a spectral feature extraction module, configured to perform spectral feature extraction on the audio input sample to obtain a first Mel spectrum, and performing spectral feature extraction on the audio output sample to obtain a second Mel spectrum; and
a spectral feature input module, configured to input the first Mel spectrum and the second Mel spectrum into the sample feature discriminator to obtain a second-type discrimination result outputted by the sample feature discriminator, the discrimination result including the first-type discrimination result and the second-type discrimination result.

In an embodiment of this application, a first error determining module may be further configured to: perform spectral feature extraction on the audio input sample to obtain a first Mel spectrum, and perform spectral feature extraction on the audio output sample to obtain a second Mel spectrum; and determine the first loss error between the encoder and the decoder based on a difference between the first Mel spectrum and the second Mel spectrum.

In an embodiment of this application, a first error determining module may be further configured to: obtain a sampling window including at least two sample scales; and perform spectral feature extraction on the audio input sample at different sample scales through the sampling window to obtain a multi-scale first Mel spectrum, and perform spectral feature extraction on the audio output sample to obtain a multi-scale second Mel spectrum.

In an embodiment of this application, the up-sampling layer includes at least two sampling channels; and the up-sampling processing module includes:
a channel feature extraction module, configured to perform feature extraction on the encoding vector of the current audio frame and the plurality of feature vectors through the at least two sampling channels in the up-sampling layer, to obtain at least two channel feature values;
an average value and a variance obtaining module, configured to obtain an average value and a variance of the at least two channel feature values; and
a normalization processing module, configured to perform normalization processing on the at least two channel feature values based on the average value and the variance.

In an embodiment of this application, the up-sampling processing module further includes:
a weighted smoothing module, configured to perform weighted smoothing processing on an average value and a variance between audio frames; and
a normalization processing module, configured to perform normalization processing on the at least two channel feature values based on the average value and the variance after weighted smoothing processing is performed.

In an embodiment of this application, the obtaining module 1510 may further include:
an encoding index value obtaining module, configured to obtain, for each audio frame in the audio frame sequence, an encoding index value of the audio frame, the encoding index value being configured for indicating a codebook vector in a codebook; and
an encoding vector determining module, configured to query the codebook for the codebook vector associated with the encoding index value, and determine an encoding vector of the audio frame based on the codebook vector.

In an embodiment of this application, a dimension of the codebook vector is lower than a dimension of the encoding vector; and the encoding vector determining module may be further configured to: perform dimension raising projection on the codebook vector to obtain the encoding vector of the audio frame.

In an embodiment of this application, the obtaining module 1510 may further include:
a quantizer obtaining module, configured to obtain the codebook and a quantizer configured to maintain the codebook, the codebook being configured for representing a mapping relationship between the encoding index value and the codebook vector;
an encoding vector sample obtaining module, configured to obtain an encoding vector sample obtained by performing encoding processing on an audio frame sample by the encoder;
a quantizer prediction module, configured to predict a codebook vector sample matching the encoding vector sample through the quantizer;
a quantizer update module, configured to update a network parameter of the quantizer based on a loss error between the encoding vector sample and the codebook vector sample; and
the encoding vector determining module, configured to query the codebook through the trained quantizer for the codebook vector associated with the encoding index value.

In an embodiment of this application, the obtaining module 1510 may further include:
a statistical parameter obtaining module, configured to obtain a statistical parameter of the encoding vector sample matching the codebook vector sample; and
a codebook update module, configured to update the codebook based on the statistical parameter, the updated codebook being configured for predicting the codebook vector sample matching the encoding vector sample next time.

In an embodiment of this application, the statistical parameter includes at least one of a vector sum or a quantity of hits, the vector sum being configured for representing an average value vector obtained by performing weighted average processing on encoding vector samples, the quantity of hits representing a quantity of encoding vector samples matching the codebook vector sample; and the codebook update module may be further configured to: perform exponential weighted smoothing on the codebook based on the vector sum; and perform Laplacian smoothing on the codebook based on the quantity of hits.

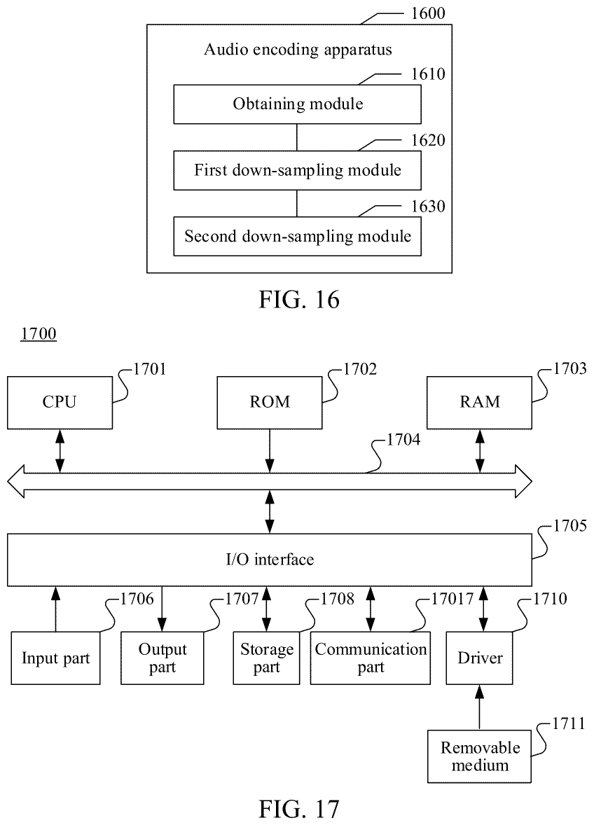

FIG. 16 is a structural block diagram of an audio encoding apparatus according to an embodiment of this application. As shown in FIG. 16, the audio encoding apparatus 1600 includes:
an obtaining module 1610, configured to obtain audio data of audio frames in an audio frame sequence;
a first down-sampling module 1620, configured to perform, in a case that a current audio frame in the audio frame sequence is encoded, down-sampling on audio data of a historical audio frame to obtain a down-sampling feature value, the historical audio frame being one or more audio frames encoded before the current audio frame in the audio frame sequence, and the down-sampling feature value being a feature vector obtained during the down-sampling and configured for describing the historical audio frame; and
a second down-sampling module 1630, configured to perform, based on the down-sampling feature value, down-sampling on audio data of the current audio frame to obtain an encoding vector of the current audio frame.

Specific details of the audio decoding apparatus provided in the embodiments of this application have been described in detail in the corresponding method embodiments, and details are not described herein again.

FIG. 17 is a schematic structural block diagram of a computer system configured to implement an electronic device according to an embodiment of this application.

The computer system 1700 of the electronic device shown in FIG. 17 is merely an example, and does not constitute any limitation on functions and use ranges of the embodiments of this application.

As shown in FIG. 17, the computer system 1700 includes a central processing unit (CPU) 1701. The CPU 1701 may perform various appropriate actions and processing according to a program stored in a read-only memory (ROM) 1702 or a program loaded from a storage part 1708 into a random access memory (RAM) 1703. The RAM 1703 further stores various programs and data required for system operations. The CPU 1701, the ROM 1702, and the RAM 1703 are connected to each other through a bus 1704. An input/output (I/O) interface 1705 is also connected to the bus 1704.

The following components are connected to the I/O interface 1705: an input part 1706 including a keyboard, a mouse, or the like; an output part 1707 including a cathode ray tube (CRT), a liquid crystal display (LCD), a speaker, or the like; a storage part 1708 including a hard disk or the like; and a communication part 17017 including a network interface card such as a local area network card, a modem, or the like. The communication part 17017 performs communication processing by using a network such as the Internet. A driver 1710 is also connected to the I/O interface 1705 as required. The removable medium 1711, such as a magnetic disk, an optical disc, a magneto-optical disk, or a semiconductor memory, is installed on the driver 1710 as required, so that a computer program read from the removable medium is installed into the storage part 1708 as required.

Particularly, according to an embodiment of this application, the processes described in the method flowcharts may be implemented as computer software programs. For example, an embodiment of this application includes a computer program product, the computer program product includes a computer program carried on a computer-readable medium, and the computer program includes program code configured for performing the methods shown in the flowcharts. In such an embodiment, the computer program may be downloaded and installed from a network through the communication part 17017, and/or installed from the removable medium 1711. When the computer program is executed by the CPU 1701, the various functions defined in the system of this application are executed.

The computer-readable medium shown in the embodiments of this application may be a computer-readable signal medium or a computer-readable storage medium or any combination of two. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to: An electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable storage medium may be any tangible medium containing or storing a program, and the program may be used by or used in combination with an instruction execution system, an apparatus, or a device. In this application, a computer-readable signal medium may include a data signal being in a baseband or propagated as a part of a carrier wave, the data signal carrying computer-readable program code. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The program code included in the computer-readable medium may be transmitted using any suitable medium, including but not limited to: a wireless medium, a wire medium, or the like, or any suitable combination thereof.

The flowcharts and block diagrams in the accompanying drawings illustrate possible system architectures, functions, and operations that may be implemented by a system, a method, and a computer program product according to various embodiments of this application. In this regard, each box in a flowchart or a block diagram may represent a module, a program segment, or a part of code. The module, the program segment, or the part of code includes one or more executable instructions used for implementing designated logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and computer instructions.

Although a plurality of modules or units of a device configured to perform actions are discussed in the foregoing detailed description, such division is not mandatory. Actually, according to the implementations of this application, the features and functions of two or more modules or units described above may be specifically implemented in one module or unit. Conversely, features and functions of one module or unit described above may be further divided into a plurality of modules or units for implementation.

Through the descriptions of the foregoing implementations, a person skilled in the art easily understands that the exemplary implementations described herein may be implemented through software, or may be implemented through software located in combination with necessary hardware. Therefore, the technical solutions of the embodiments of this application may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to the embodiments of this application.

Other embodiments of this application will be apparent to a person skilled in the art from consideration of the specification and practice of this application. This application is intended to cover any variations, uses, or adaptive changes of this application. These variations, uses, or adaptive changes follow the general principles of this application and include common general knowledge or common technical means in the art, which are not disclosed in this application.

It is to be understood that this application is not limited to the precise structures described above and shown in the accompanying drawings, and various modifications and changes can be made without departing from the scope of this application. The scope of this application is limited by the appended claims only.

What is claimed is:

1. An audio decoding method, performed by a computer device, comprising:
obtaining encoding vectors of audio frames in an audio frame sequence;
performing, in response to a current audio frame in the audio frame sequence being to be decoded, up-sampling on an encoding vector of a historical audio frame to obtain an up-sampling feature value describing the historical audio frame, the historical audio frame including one or more audio frames decoded before the current audio frame in the audio frame sequence; and
performing, based on the up-sampling feature value, up-sampling on an encoding vector of the current audio frame to obtain decoded data of the current audio frame.

2. The audio decoding method according to claim 1, wherein:
performing up-sampling on the encoding vector of the historical audio frame to obtain the up-sampling feature value includes performing up-sampling on the encoding vector of the historical audio frame using a plurality of up-sampling layers of a decoder to obtain the up-sampling feature value including a plurality of feature vectors, respectively; and
performing, based on the up-sampling feature value, up-sampling on the encoding vector of the current audio frame to obtain the decoded data of the current audio frame includes:
inputting the encoding vector of the current audio frame into the decoder, and inputting the plurality of feature vectors into the plurality of up-sampling layers correspondingly; and
performing up-sampling processing on the encoding vector of the current audio frame and the plurality of feature vectors through the plurality of up-sampling layers, to obtain the decoded data of the current audio frame.

3. The audio decoding method according to claim 2, further comprising, before inputting the encoding vector of the current audio frame into the decoder:
obtaining an encoder including a plurality of down-sampling layers;
performing encoding and decoding processing on an audio input sample through the encoder and the decoder to obtain an audio output sample;
determining a first loss error between the encoder and the decoder based on the audio input sample and the audio output sample;
performing type discrimination on the audio input sample and the audio output sample through a sample discriminator to obtain a discrimination result, and determining a second loss error of the sample discriminator based on the discrimination result; and
performing generative adversarial training on the encoder, the decoder, and the sample discriminator based on the first loss error and the second loss error, to update network parameters of the encoder, the decoder, and the sample discriminator.

4. The audio decoding method according to claim 3, wherein:
the sample discriminator includes an original sample discriminator and a sample feature discriminator; and
performing type discrimination on the audio input sample and the audio output sample through the sample discriminator includes:
inputting the audio input sample and the audio output sample into the original sample discriminator to obtain a first-type discrimination result;
performing spectral feature extraction on the audio input sample to obtain a first Mel spectrum, and performing spectral feature extraction on the audio output sample to obtain a second Mel spectrum; and
inputting the first Mel spectrum and the second Mel spectrum into the sample feature discriminator to obtain a second-type discrimination result, the discrimination result including the first-type discrimination result and the second-type discrimination result.

5. The audio decoding method according to claim 3, wherein determining the first loss error includes:
performing spectral feature extraction on the audio input sample to obtain a first Mel spectrum, and performing spectral feature extraction on the audio output sample to obtain a second Mel spectrum; and
determining the first loss error based on a difference between the first Mel spectrum and the second Mel spectrum.

6. The audio decoding method according to claim 5, wherein performing spectral feature extraction on the audio input sample to obtain the first Mel spectrum, and performing spectral feature extraction on the audio output sample to obtain the second Mel spectrum includes:
obtaining a sampling window including at least two sample scales; and
performing spectral feature extraction on the audio input sample at different ones of the at least two sample scales through the sampling window to obtain a multi-scale first Mel spectrum, and performing spectral feature extraction on the audio output sample to obtain a multi-scale second Mel spectrum.

7. The video decoding method according to claim 2, wherein:
the up-sampling layer includes at least two sampling channels; and
performing up-sampling processing on the encoding vector of the current audio frame and the plurality of feature vectors through the plurality of up-sampling layers includes:
performing feature extraction on the encoding vector of the current audio frame and the plurality of feature vectors through the at least two sampling channels in the up-sampling layer, to obtain at least two channel feature values;
obtaining an average value and a variance of the at least two channel feature values; and
performing normalization processing on the at least two channel feature values based on the average value and the variance.

8. The audio decoding method according to claim 7, further comprising, before performing normalization processing on the at least two channel feature values:
performing weighted smoothing processing on an average value and a variance among the audio frames to obtain a processed average value and a processed variance;
wherein performing normalization processing on the at least two channel feature values includes:
performing normalization processing on the at least two channel feature values based on the processed average value and the processed variance.

9. The audio decoding method according to claim 1, wherein obtaining the encoding vectors includes:
for one audio frame in the audio frame sequence, obtaining an encoding index value of the one audio frame; and
querying a codebook for a codebook vector associated with the encoding index value, and determining an encoding vector of the one audio frame based on the codebook vector.

10. The audio decoding method according to claim 9, wherein:
a dimension of the codebook vector is lower than a dimension of the encoding vector; and
determining the encoding vector of the one audio frame based on the codebook vector includes:
performing dimension raising projection on the codebook vector to obtain the encoding vector of the one audio frame.

11. The audio decoding method according to claim 9, further comprising, before querying the codebook:
obtaining a quantizer configured to maintain the codebook; and
training the quantizer, including:
obtaining an encoding vector sample obtained by an encoder performing encoding processing on an audio frame sample;
predicting a codebook vector sample matching the encoding vector sample through the quantizer; and
updating a network parameter of the quantizer based on a loss error between the encoding vector sample and the codebook vector sample, to obtained a trained quantizer;
wherein querying the codebook includes:
querying, through the trained quantizer, the codebook for the codebook vector associated with the encoding index value.

12. The audio decoding method according to claim 11, further comprising, after predicting the codebook vector sample matching the encoding vector sample:
obtaining a statistical parameter of the encoding vector sample matching the codebook vector sample; and
updating the codebook based on the statistical parameter to obtain an updated codebook configured for predicting the codebook vector sample matching the encoding vector sample next time.

13. The audio decoding method according to claim 12, wherein:
the statistical parameter includes at least one of a vector sum or a quantity of hits, the vector sum representing an average value vector obtained by performing weighted average processing on encoding vector samples, and the quantity of hits representing a quantity of encoding vector samples matching the codebook vector sample; and
updating the codebook based on the statistical parameter includes:
performing exponential weighted smoothing on the codebook based on the vector sum; and
performing Laplacian smoothing on the codebook based on the quantity of hits.

14. A non-transitory computer-readable storage medium storing one or more computer programs that, when executed by one or more processors, cause the one or more processors to perform the method according to claim 1.

15. An audio encoding method, performed by a computer device, comprising:
obtaining audio data of audio frames in an audio frame sequence;
performing, in response to a current audio frame in the audio frame sequence being to be encoded, down-sampling on audio data of a historical audio frame to obtain a down-sampling feature value describing the historical audio frame, the historical audio frame including one or more audio frames encoded before the current audio frame in the audio frame sequence; and
performing, based on the down-sampling feature value, down-sampling on the audio data of the current audio frame to obtain an encoding vector of the current audio frame.

16. A non-transitory computer-readable storage medium storing one or more computer programs that, when executed by one or more processors, cause the one or more processors to perform the method according to claim 15.

17. An electronic device comprising:
one or more processors; and
one or more memories storing one or more computer programs that, when executed by the one or more processors, cause the electronic device to perform the method according to claim 15.

18. An electronic device comprising:
one or more processors; and
one or more memories storing one or more computer programs that, when executed by the one or more processors, cause the electronic device to:
obtain encoding vectors of audio frames in an audio frame sequence;
perform, in response to a current audio frame in the audio frame sequence being to be decoded, up-sampling on an encoding vector of a historical audio frame to obtain an up-sampling feature value describing the historical audio frame, the historical audio frame including one or more audio frames decoded before the current audio frame in the audio frame sequence; and
perform, based on the up-sampling feature value, up-sampling on an encoding vector of the current audio frame to obtain decoded data of the current audio frame.

19. The device according to claim 18, wherein the one or more computer programs, when executed by the one or more processors, further cause the electronic device to:
perform up-sampling on the encoding vector of the historical audio frame using a plurality of up-sampling layers of a decoder to obtain the up-sampling feature value including a plurality of feature vectors, respectively;
input the encoding vector of the current audio frame into the decoder, and input the plurality of feature vectors into the plurality of up-sampling layers correspondingly; and
perform up-sampling processing on the encoding vector of the current audio frame and the plurality of feature vectors through the plurality of up-sampling layers, to obtain the decoded data of the current audio frame.

20. The device according to claim 19, wherein the one or more computer programs, when executed by the one or more processors, further cause the electronic device to, before inputting the encoding vector of the current audio frame into the decoder:
obtain an encoder including a plurality of down-sampling layers;
perform encoding and decoding processing on an audio input sample through the encoder and the decoder to obtain an audio output sample;
determine a first loss error between the encoder and the decoder based on the audio input sample and the audio output sample;
perform type discrimination on the audio input sample and the audio output sample through a sample discriminator to obtain a discrimination result, and determining a second loss error of the sample discriminator based on the discrimination result; and
perform generative adversarial training on the encoder, the decoder, and the sample discriminator based on the first loss error and the second loss error, to update network parameters of the encoder, the decoder, and the sample discriminator.
